(19) United States
(12) Patent Application Publication
(10) Pub. No.: US 2022/0342955 A1
(43) Pub. Date: Oct. 27, 2022

(54) INFORMATION PROCESSING APPARATUS, INFORMATION PROCESSING METHOD, AND PROGRAM

(71) Applicant: NEC Corporation, Minato-ku, Tokyo (JP)

(72) Inventor: Kanako KOBORI, Tokyo (JP)

(73) Assignee: NEC Corporation, Minato-ku, Tokyo (JP)

(21) Appl. No.: 17/640,432

(22) PCT Filed: Aug. 21, 2020
(86) PCT No.: PCT/JP2020/031576

§ 371 Date: Mar. 4, 2022

(30) Foreign Application Priority Data
Sep. 10, 2019 (JP) 2019-164594

(51) Int. Cl. G06F 16/958; G06F 16/955; G06F 16/901

(52) U.S. Cl. CPC G06F 16/986; G06F 16/9566; G06F 16/9027

(57) ABSTRACT

An information processing apparatus (100) includes a specification unit (102) that accepts a plurality of tags being specified at a timing before an input for a search, and a storage processing unit (104) that stores, in a history DB (112) and a tag history DB (116), browsing information including a uniform resource locator (URL) of a browsed web page, in association with the specified tags.

### TECHNICAL FIELD

The present invention relates to an information processing apparatus, an information processing method, and a program.

### BACKGROUND ART

Patent Documents 1 to 3 each describe a technique for collecting, storing, and managing information on the web. For example, Patent Document 1 describes that index information for a document actually generated, edited, or browsed by a user himself/herself is automatically generated by sensing operations in a browsing unit and automatically generating index information when a previously set operation is performed, and the document can be searched for and called later by use of the index information.

Patent Document 2 describes acquiring information on a network, generating an index database by performing index-processing on the acquired information, and searching for latest information. Patent Document 3 describes a bookmark and tag setting apparatus that automatically saves, organizes, and provides, to a user, a search word used by the user or a clicked search result, and improves convenience of an information search and information organization.

### RELATED DOCUMENT

### Patent Document

[Patent Document 1] Japanese Patent Application Publication No. 2000-285134
[Patent Document 2] Japanese Patent Application Publication No. 2001-222535
[Patent Document 3] Japanese Patent Application Publication No. 2008-071259

### SUMMARY OF THE INVENTION

### Technical Problem

In a case of consulting the web for information, when again accessing the same website, it is preferred that a uniform resource location (URL) of the website is registered. However, when URLs increase, it becomes difficult to manage what kinds of sites the URLs are.

The present invention has been made in view of the circumstance described above, and an object thereof is to provide a technique for properly and efficiently collecting necessary information from a large amount of information on the web.

### Solution to Problem

In order to solve the problem described above, each aspect of the present invention adopts each of the following configurations.

A first aspect relates to an information processing apparatus. The information processing apparatus according to the first aspect includes: a specification unit that accepts a plurality of tags being specified at a timing before an input for a search; and

a storage processing unit that stores, in a storage unit, browsing information including a uniform resource locator (URL) of a browsed web page, in association with the specified tags.

A second aspect relates to an information processing method executed by at least one computer. The information processing method according to the second aspect executed by an information processing apparatus, and includes:

accepting a plurality of tags being specified at a timing before an input for a search; and

storing, in a storage unit, browsing information including a uniform resource locator (URL) of a browsed web page, in association with the specified tags.

Note that, another aspect of the present invention may be a program that causes at least one computer to execute the method according to the second aspect described above, or may be a computer-readable storage medium recording such a program. The storage medium includes a non-transitory tangible medium.

The computer program includes a computer program code that causes, when executed by a computer, the computer to implement the processing method on an information processing apparatus.

Note that, each of conversions of any combination of above components and an expression of the present invention between a method, an apparatus, a system, a storage medium, a computer program, and the like is also effective as a form of the present invention.

Moreover, each of a variety of components of the present invention does not necessarily need to be individually independent existence, and may be in such a form that a plurality of components are formed as one member, one component is formed of a plurality of members, a certain component is a part of another component, or a part of a certain component overlaps a part of another component.

Moreover, although a plurality of procedures are described in order in each of the method and the computer program of the present invention, an order of the descriptions does not limit an order of executing the plurality of procedures. Thus, when each of the method and the computer program of the present invention is implemented, an order of the plurality of procedures can be changed to an extent that causes no problem in terms of content.

Furthermore, a plurality of procedures of each of the method and the computer program of the present invention are not limited to being executed at individually differing timings. Thus, a plurality of procedures may be in such a form that, during execution of a certain procedure, another procedure occurs, or an execution timing of a certain procedure and an execution timing of another procedure partly or entirely overlap each other.

### Advantageous Effects of Invention

Each of the aspects described above can provide a technique for properly and efficiently collecting necessary information from various information scattered on the Internet.

### BRIEF DESCRIPTION OF THE DRAWINGS

FIG. 1 is a functional block diagram illustrating a logical configuration of an information processing apparatus according to the present example embodiment.

FIG. 2 is a block diagram illustrating a hardware configuration example of a computer that achieves the information processing apparatus.

FIG. 3 is a diagram illustrating one example of a data structure of a history DB.

FIG. 4 is a diagram illustrating one example of a data structure of a tag DB.

FIG. 5 is a diagram illustrating one example of a tag selection editor screen.

FIG. 6 is a diagram illustrating one example of a data structure of a tag history DB.

FIG. 7 is a flowchart illustrating one example of a procedure of an information analysis.

FIG. 8 is a flowchart illustrating one example of an operation of the information processing apparatus according to the present example embodiment.

FIG. 9 is a diagram for describing a detailed function of the information processing apparatus and a flow of data.

FIG. 10 is a diagram for describing a change of a record of a database during an operation flow in FIG. 8.

FIG. 11 is a diagram illustrating one example of a history screen.

FIG. 12 is a diagram illustrating one example of a data structure of a tag mode DB.

FIG. 13 is a flowchart illustrating one example of an operation of the information processing apparatus.

FIG. 14 is a diagram for describing a detailed function of the information processing apparatus and a flow of data.

FIG. 15 is a diagram for describing a change of a record of a database during an operation flow in FIG. 13.

FIG. 16 is a diagram illustrating one example of a history screen.

FIG. 17 is a functional block diagram illustrating a logical configuration of the information processing apparatus according to the present example embodiment.

FIG. 18 is a flowchart illustrating one example of an operation of the information processing apparatus according to the present example embodiment.

FIG. 19 is a functional block diagram illustrating a logical configuration of the information processing apparatus according to the present example embodiment.

FIG. 20 is a flowchart illustrating one example of an operation of the information processing apparatus according to the present example embodiment.

FIG. 21 is a functional block diagram illustrating a logical configuration of the information processing apparatus according to the present example embodiment.

FIG. 22 is a flowchart illustrating one example of an operation of the information processing apparatus according to the present example embodiment.

FIG. 23 is a diagram illustrating one example of a data structure of information relating to a tag of a tree structure.

FIG. 24 is a diagram illustrating one example of a tree screen.

FIG. 25 is a diagram illustrating an example of a data structure of information relating to an association line added to the tag of the tree structure in FIG. 23.

FIG. 26 is a diagram illustrating an example in which a tree screen is included in a history screen.

FIG. 27 is a functional block diagram illustrating a logical configuration of a modified example of the information processing apparatus.

### DESCRIPTION OF EMBODIMENTS

Hereinafter, an example embodiment of the present invention is described by use of the drawings. Note that, in all of the drawings, a similar component is assigned with a similar reference sign, and description thereof is not repeated, as appropriate.

### First Example Embodiment

There are three tasks below for performing an information analysis on the Internet.

(a) Collection: collecting a plurality of pieces of site information having a possibility of including necessary information.
(b) Processing: saving information that seems to be useful among accessed sites, with additional information attached thereto
(c) Processing: based on the additional information, choosing information, and processing the information into necessary information, while browsing the site again.

Additional information is information that allows a content of information described in a site to be recognized later, or facilitates finding through a search. In the present example embodiment, the additional information is referred to as a tag. In the present example embodiment, a tag is a piece of data including a character string that provides a meaning to information acquired as a result of searching, or a character string such as a word or a phrase for classifying or identifying information acquired as a result of searching. In another example embodiment, a tag further includes another piece of information.

Necessary information is information generated from a result of analysis for accomplishing a purpose of an information analysis.

In order to perform an information analysis on the Internet, an information processing apparatus 100 according to the present example embodiment executes an application having a browser function, connects to the Internet, and displays a website by performing a search for necessary information or the like, or stores information of the website. Note that, a tag added to information acquired by searching the Internet may be a word or a phrase differing from a search keyword used at a search.

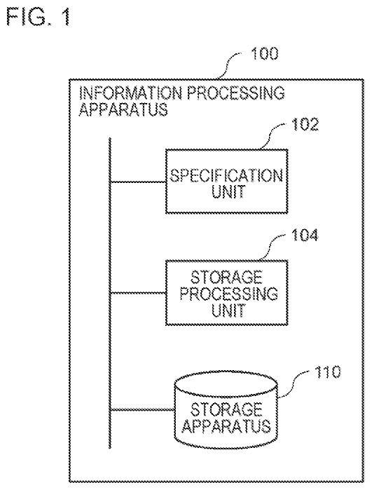

FIG. 1 is a functional block diagram illustrating a logical configuration of the information processing apparatus 100 according to the present example embodiment.

The information processing apparatus 100 includes a specification unit 102 and a storage processing unit 104.

The specification unit 102 accepts a plurality of tags being specified at a timing before an input for a search. The storage processing unit 104 stores, in a storage apparatus 110 (a history DB 112 and a tag history DB 116 that are described later), browsing information including a uniform resource locator (URL) of a browsed web page, in association with the specified tag.

The storage apparatus 110 includes a plurality of databases (hereinafter, also referred to as a DB) described later. However, the information processing apparatus 100 is not limited to a database structure. Data to be stored in the information processing apparatus 100 may be in another file format (e.g., comma-separated values (CSV), a text file, or the like). Moreover, an image, a video file, or the like included in a site may be stored in the storage apparatus 110. The storage apparatus 110 may be provided inside the information processing apparatus 100, or may be provided outside. The storage apparatus 110 may be a plurality of storage apparatuses physically.

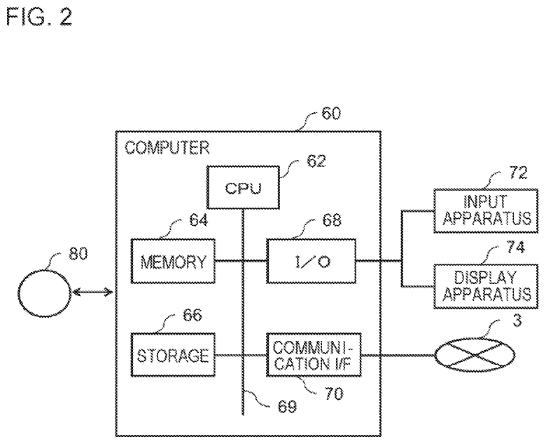

FIG. 2 is a block diagram illustrating a hardware configuration example of a computer 60 that achieves the information processing apparatus 100. The information processing apparatus 100 may be achieved by a plurality of the computers 60.

The computer 60 includes a central processing unit (CPU) 62, a memory 64, a program 80 that achieves components of each server and a user terminal loaded on the memory 64, a storage 66 storing the program 80, an input/output (I/O) 68, and an interface (communication I/F 70) for connection of a communication network 3.

The CPU 62, the memory 64, the storage 66, the I/O 68, and the communication I/F 70 are connected to one another via a bus 69, and each server and a user terminal are each controlled by the CPU 62. However, a method of connecting the CPU 62 and the like to one another is not limited to bus connection.

The memory 64 is a memory such as a random access memory (RAM) or a read only memory (ROM). The storage 66 is a storage apparatus such as a hard disk, a solid state drive (SSD), or a memory card.

The storage 66 may be a memory such as a RAM or a ROM. The storage 66 may be provided inside the computer 60, or may be provided outside the computer 60 and wiredly or wirelessly connected to the computer 60 when the computer 60 is accessible. Alternatively, the storage 66 may be removably provided to the computer 60.

The CPU 62 can achieve each function of each unit of the information processing apparatus 100 in FIG. 1, by reading the program 80 stored in the storage 66 onto the memory 64 and executing the read program 80.

The I/O 68 performs input/output control of data and a control signal between the computer 60 and another input/output apparatus. The another input/output apparatus includes apparatuses connected to the computer 60, for example, an input apparatus 72 such as a keyboard, a touch panel, a mouse, and a microphone, an output apparatus (not illustrated) such as a display (indicated as a display apparatus 74 in the drawing), a printer, and a speaker, and an interface between the input/output apparatus and the computer 60. Further, the I/O 68 may perform input/output control of data to/from a reading or writing apparatus (not illustrated) of another storage medium.

The communication IN 70 is a network connection interface for performing communication between the computer 60 and an external apparatus. The communication OF 70 may be a network interface for connecting to a wired circuit, or may be a network interface for connecting to a wireless circuit. For example, the computers 60 that achieve the information processing apparatus 100 are connected to one another via the communication network 3 by the communication IN 70.

Each component of the information processing apparatus 100 in FIG. 1 is achieved by any combination of hardware and software of the computer 60 in FIG. 2. Then, it is understood by a person skilled in the art that there are various modified examples of methods and apparatuses for the achievement. A functional block diagram illustrating the information processing apparatus 100 according to each example embodiment described below illustrates not a configuration on a hardware basis but a block on a logical function basis. Moreover, in each drawing, a configuration of a part that does not concern an essence of the present invention is omitted, and is not illustrated.

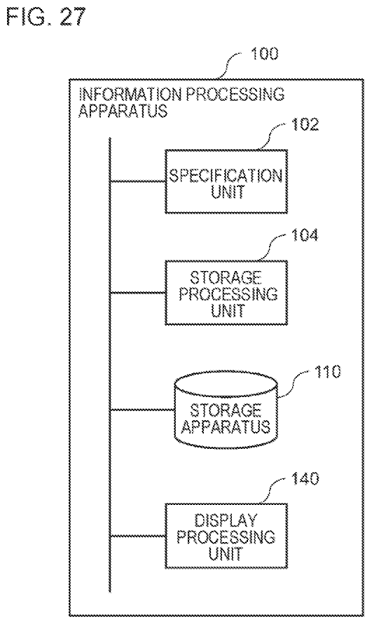

The storage processing unit 104 further stores, in the history DB 112, a title of a browsed web page by further including the title in browsing information. The information processing apparatus 100 can further include a display processing unit 140 (FIG. 27) that displays, on a display unit (the display apparatus 74), the title of the web page and the tags in association with each other.

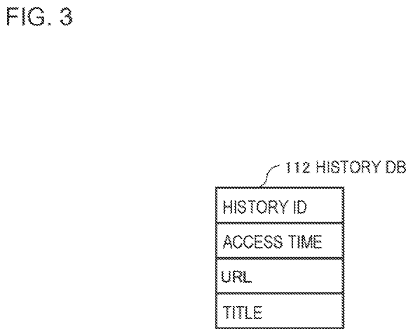

FIG. 3 is a diagram illustrating one example of a data structure of the history DB 112 that stores browsing information. The history DB 112 stores, in association with one another, identification information (referred to as a history ID) assigned to each piece of browsing information, time information of access to a web page, a URL of the web page, and a title of the web page. However, the history DB 112 may include at least the URL of the web page.

Furthermore, in the information processing apparatus 100, a plurality of tags may be previously stored in a tag DB 114. In this case, the specification unit 102 accepts at least one tag being specified from among a plurality of tags stored in the tag DB 114. The storage processing unit 104 stores, when a web page is browsed, a preliminarily specified tag in association with browsing information. However, a tag may be associated with at least a URL of a web page.

A plurality of tags specified by the specification unit 102 at a timing before an input for a search are stored in the tag DB 114. A timing before an input for a search is not particularly limited as long as the timing is a timing before a site to be browsed is selected from a search result acquired by executing an Internet search and a web page is displayed or downloaded. Then, the storage processing unit 104 stores, when a web page is browsed, a previously specified tag in association with browsing information.

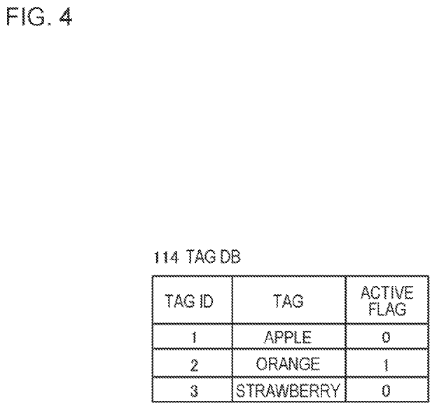

FIG. 4 is a diagram illustrating one example of a data structure of the tag DB 114. Tag information is stored in the tag DB 114, and the tag information includes a tag ID identifying a tag, the tag, and an active flag. The tag DB 114 stores a plurality of tags, but, before a search, a tag desired to be assigned to a result which will be acquired by the search can be specified. In the example of the tag DB 114 in FIG. 4, an active flag of a tag being specified to be assigned is at “1”, and an active flag of a tag that is not specified is at “0”, but the present invention is not limited thereto.

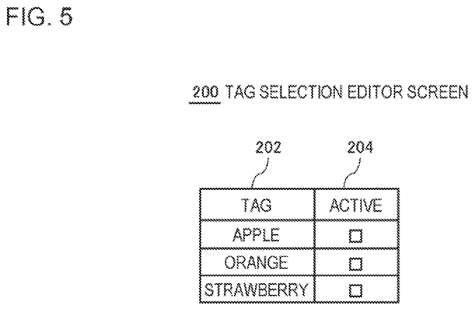

Tag information stored in the tag DB 114 may be editable on an editor screen by an operator. The specification unit 102 accepts a tag input to a tag selection editor screen 200 and specified by the operator, and stores, in the tag DB 114, the tag specified by the operator. FIG. 5 is a diagram illustrating one example of the tag selection editor screen 200. The information processing apparatus 100 can display a variety of screens including the tag selection editor screen 200 on the display apparatus 74 in FIG. 2.

The tag selection editor screen 200 includes a tag column 202, and an active specification column 204 that specifies whether to assign a tag in the tag column 202 to browsing information. The tag column 202 displays a previously specified tag. The active specification column 204 is, for example, a checkbox, and a checked tag is assigned to browsing information. Regarding a tag checked in the active specification column 204, an active flag of the tag DB 114 in FIG. 4 is set to “1”. Regarding a tag unchecked in the active specification column 204, an active flag of the tag DB 114 in FIG. 4 is set to “0”.

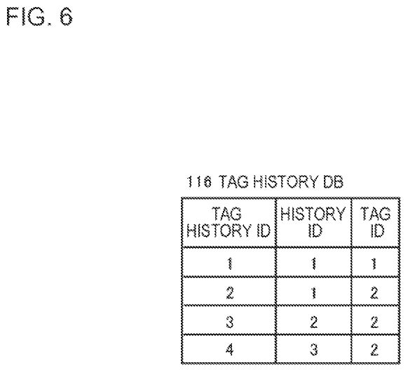

When a tag specified by tag information is assigned to browsing information by the storage processing unit 104, history information of tag assignment is stored in the tag history DB 116. FIG. 6 is a diagram illustrating one example of a data structure of the tag history DB 116. History information of tag assignment to be stored in the tag history DB 116 is stored associating a tag history ID identifying history information, a history ID of browsing information to which a tag is assigned, and a tag ID of the tag assigned to the browsing information. For example, for browsing information whose history ID is 1 in the history DB 112 in FIG. 3, since two tags “apple” and “orange” are assigned, 1 and 2 that are tag IDs of “apple” and “orange” are each associated thereto.

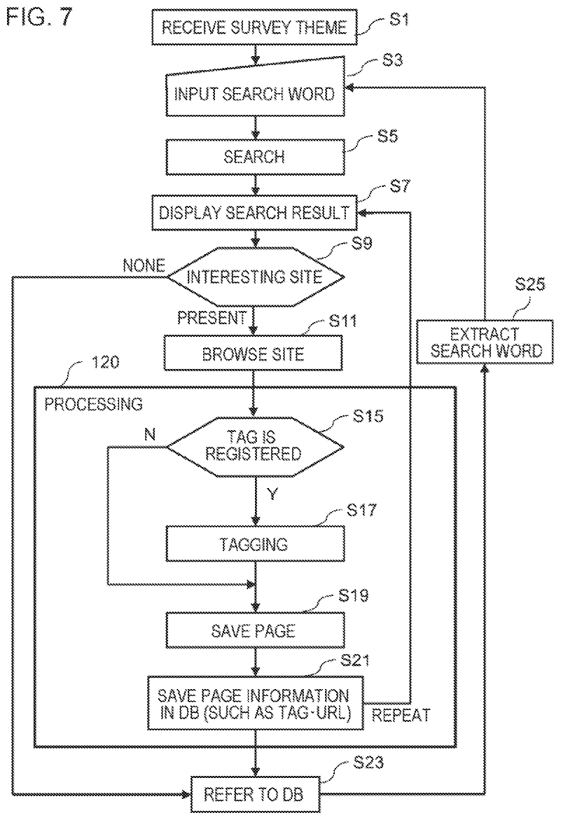

Herein, a procedure of surveying and analyzing information on the Internet by use of the information processing apparatus 100 is described. FIG. 7 is a flowchart illustrating one example of a procedure of an information analysis.

First, an analyzer receives a theme of a survey (step S1). The analyzer inputs a search word for the survey on a search engine site by use of a browser (step S3), and executes a search (step S5). A search result is displayed (step S7). The analyzer browses the search result, and, when there is an interesting site (present in step S9), accesses and browses the site (step S11).

Then, processing 120 in steps S15 to S21 is implemented by the storage processing unit 104. The storage processing unit 104 refers to the tag DB 114, and, when there is a tag to which an active flag is set (Y in step S15), associates the tag with browsing information of the browsed site (step S17). When there is no tag to which an active flag is set (N in step S15), step S17 is bypassed.

Then, the storage processing unit 104 saves browsing information of the browsed page of the site in the history DB 112 (step S19). Further, as described in a later-described example embodiment, when saving of a browsed page is previously specified, the storage processing unit 104 may save contents themselves of the browsed page in a previously specified file format. For example, contents are saved through a browser in at least one of file formats such as a hypertext markup language (HTML) file, a portable document format (PDF) file, a text file, and an image file of a screenshot.

Then, the storage processing unit 104 saves browsing information (a URL and the like) in the tag history DB 116 in association with a tag (step S21). When there is any other interesting site among search results, a return is made to step S7, and processing is repeated.

When there is no interesting site in step S9 (none in step S9), the analyzer refers to information about previous survey contents (step S23), and extracts a new search word (step S25). Then, returning to the step S3, the analyzer inputs the extracted new word, and performs a re-search.

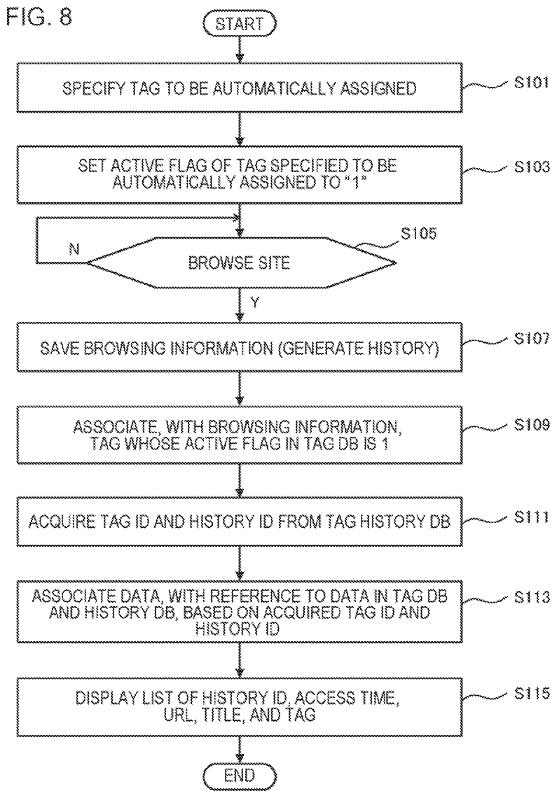

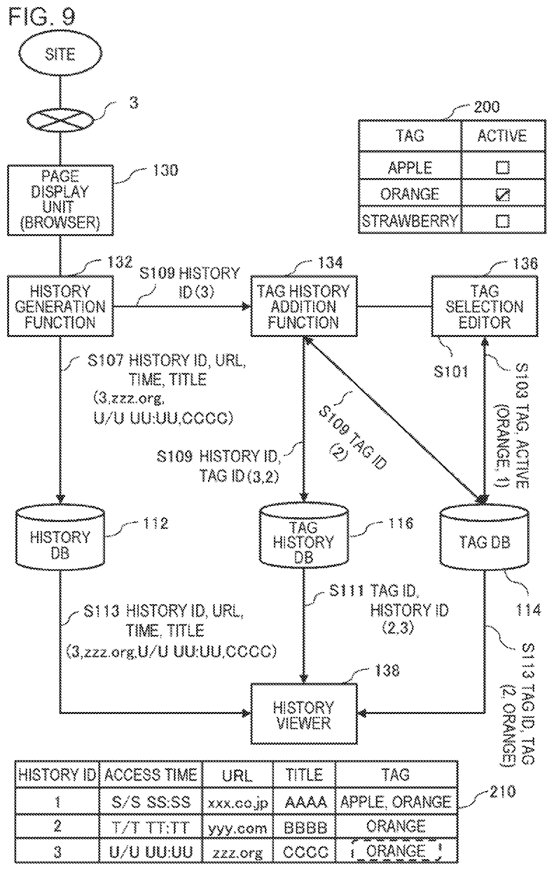

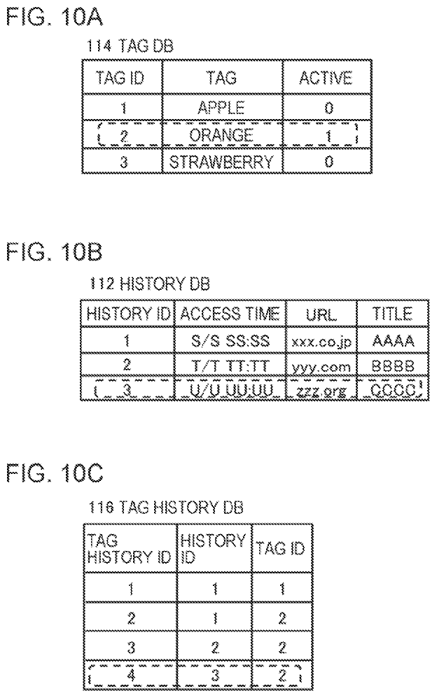

The information processing apparatus 100 automatically performs processing for assigning a tag to browsing information, in the processing 120 of the information analysis procedure in FIG. 7. An operation of the information processing apparatus 100 is described in detail below. FIG. 8 is a flowchart illustrating one example of an operation of the information processing apparatus 100 according to the present example embodiment. FIG. 9 is a diagram for describing a detailed function of the information processing apparatus 100 and a flow of data. FIG. 10 is a diagram for describing a change of a record of a database during an operation flow in FIG. 8.

In FIG. 9, the information processing apparatus 100 includes a page display unit 130, a history generation function 132, a tag history addition function 134, a tag selection editor 136, and a history viewer 138.

The tag selection editor 136 is equivalent to the specification unit 102 in FIG. 1. The history generation function 132 and the tag history addition function 134 are equivalent to the storage processing unit 104 in FIG. 1.

The page display unit 130 is, for example, a browser. The history viewer 138 displays a browsing history generated by the storage processing unit 104 of the information processing apparatus 100.

The history generation function 132, the tag history addition function 134, the tag selection editor 136, and the history viewer 138 can be each functionally added as, for example, an add-on of a browser (the page display unit 130).

The tag selection editor 136 displays the tag selection editor screen 200, and accepts a specification of a tag. The history viewer 138 is equivalent to the display processing unit 140, and displays a history screen 210.

First, the tag selection editor 136 (the specification unit 102) displays the tag selection editor screen 200, and accepts a specification of a tag to be automatically assigned to browsing information (step S101). Herein, among a plurality of tags, the active specification column 204 of “orange” is checked.

The tag selection editor 136 (the specification unit 102) sets an active flag, in the tag DB 114, of a tag specified to be automatically assigned is set to “1” (step S103). In an example in FIG. 10A, an active flag of “orange” of a tag whose tag ID is 2 is set to “1”. The steps S101 and S103 are performed after a survey theme is received in the step S1 in FIG. 7 and before an input of a search word in the step S3.

Herein, an analyzer performs a search with the page display unit 130 (browser) (corresponding to the steps S3 and S5 in FIG. 7), selects a site desired to browse from a search result, and accesses and browses the site. When the site is browsed by the analyzer (YES in step S105), the history generation function 132 (the storage processing unit 104) saves, in the history DB 112, an access time, a URL, and a title as browsing information of the browsed site, and generates a history (step S107). In an example in FIG. 10B, a record whose history ID is 3 is added to the history DB 112. Step S107 in FIG. 8 is equivalent to the step S19 in FIG. 7.

Various timings can be conceived as a timing at which the storage processing unit 104 determines in the step S105 that an analyzer has browsed the site. For example, the timing is at least one of a time when a selection operation of a site is accepted for browsing, a time when a selected site is accessed, and a time when downloading of a web page of a selected site is completed.

Then, the tag history addition function 134 (the storage processing unit 104) stores, in the tag history DB 116, a tag whose active flag is 1 in the tag DB 114, and associates the tag with browsing information (step S109). Step S109 in FIG. 8 is equivalent to the step S21 in FIG. 7. In an example in FIG. 10C, a record whose tag history ID in the tag history DB 116 is 4 is added, and a history ID (3) and a tag ID (2) are associated.

When another page is browsed, browsing information is further added to the history DB 112 in a similar way, and association information of the browsing information and a tag is added to the tag history DB 116 as well in a similar way. In this way, a browsing history is accumulated. Moreover, assignment of a tag can be performed by reception of an operation of an operator at any timing, other than automatic assignment. For example, a tag may be able to be manually assigned in such a case that an operator desires to assign a tag other than a tag being set to be automatically assigned, after browsing a page. For example, an operation menu for manually assigning a tag is opened, an input to a text input box or selection in a pull-down menu is accepted, and a tag may be able to be set. Further, an already assigned tag may be able to be deleted by, for example, selection of the assigned tag, display of an operation menu with a right click, and selection or the like of a delete operation. According to an accepted operation content, the storage processing unit 104 adds or deletes the tag.

An accumulated browsing history can be browsed by use of the history viewer 138. The history viewer 138 displays the history screen 210. In this instance, first, the tag history DB 116 is referred to, and a pair of a tag ID and a history ID is acquired (step S111). Then, pieces of data being relevant to the acquired tag ID and history ID are acquired from the tag DB 114 and the history DB 112, respectively, and associated each other (step S113). In the example in FIG. 9, a tag (orange) is associated with browsing information (an access time, a URL, and a title) whose history ID in the history screen 210 is 3.

Then, the history viewer 138 displays, on the history screen 210, the browsing information and the tag acquired in the step S113 (step S115). Processing in the steps S111 to step S115 are repeated for each record in the tag history DB 116.

In the example embodiment, “acquisition” includes at least either one of fetching, by an own apparatus, data or information stored in another apparatus or a storage medium (active acquisition), and inputting, into an own apparatus, data or information output from another apparatus (passive acquisition). Examples of active acquisition include requesting or inquiring of the another apparatus and receiving a reply thereof, accessing the another apparatus or the storage medium and reading, and the like. Moreover, an example of passive acquisition includes receiving information given by distribution (or transmission, push notification, or the like), and the like. Further, “acquisition” may include selecting and acquiring from received data or information, or selecting and receiving distributed data or information.

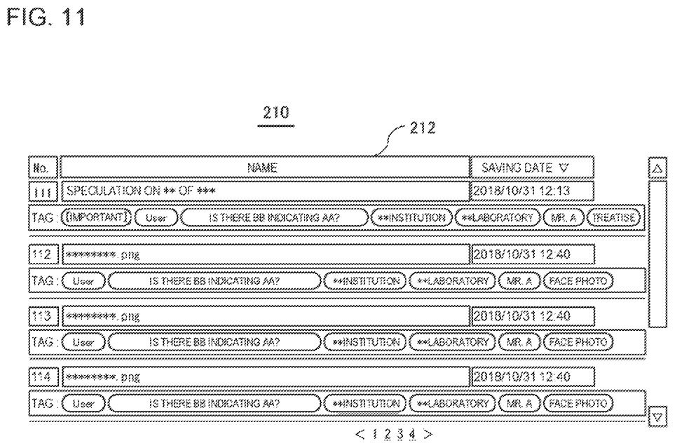

FIG. 11 is a diagram illustrating one example of the history screen 210 generated in this way. The history screen 210 includes a browsing information list display column 212 including a title (name) of a site, a saving date (or an access time), and a plurality of assigned tags.

As described above, the information processing apparatus 100 according to the present example embodiment can store a tag specified by the specification unit 102 before an input for a search, in association with information about a browsed site. Thus, when analyzed later, accumulated browsing information can be efficiently analyzed, based on a tag.

### Second Example Embodiment

An information processing apparatus 100 according to the present example embodiment is the same as that according to the example embodiment described above except that not only a character string but also a mode of saving contents of a web page is previously specified as a tag, and the contents of the web page are saved in browsing information in a specified mode.

A specification unit 102 accepts a specification of a saving mode of a web page. A storage processing unit 104 stores the web page in a storage apparatus 110 in the specified saving mode.

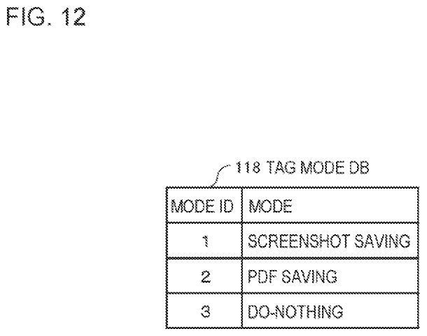

FIG. 12 is a diagram illustrating one example of a data structure of a tag mode DB 118. The tag mode DB 118 includes a tag ID identifying a tag mode, and a saving mode of a tag. Herein, saving modes of a tag include screenshot saving, PDF saving, and do-nothing (i.e., data saving is not performed, and a tag such as a character string is assigned).

A display processing unit 140 displays a saved web page on a display unit.

An image file, a PDF file, and the like of a screenshot are saved in a previously determined folder or a folder specified at any time of the storage apparatus 110. For example, the storage processing unit 104 assigns as a file name (path name) of a file to be saved, in accordance with a predetermined rule using a history ID, an access time, or the like. Thus, the display processing unit 140 can read a file in which a web page being relevant to the history ID is saved.

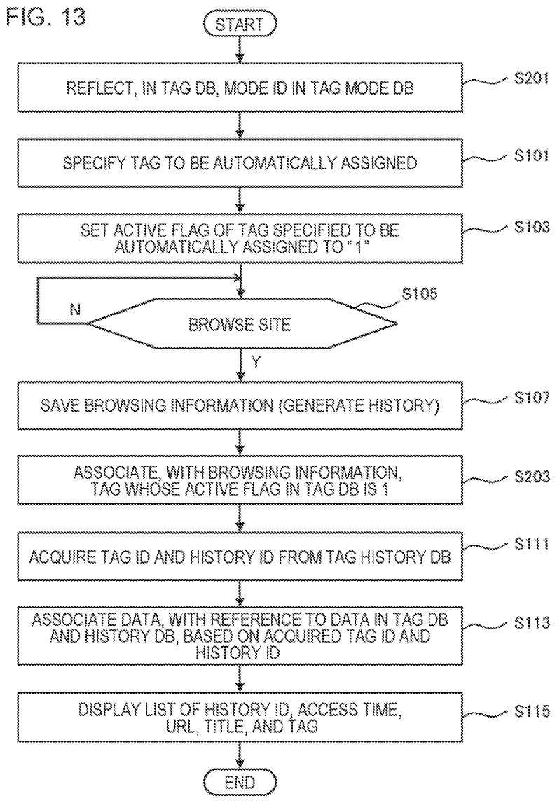

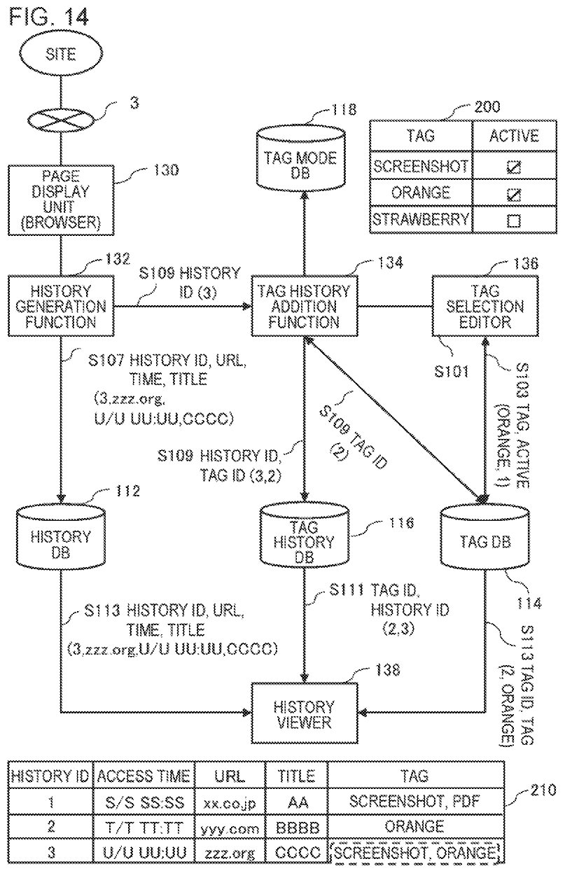

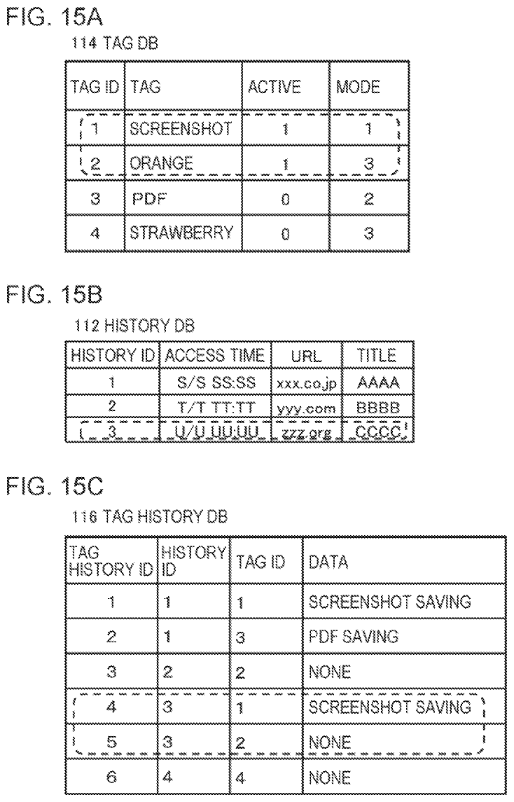

FIG. 13 is a flowchart illustrating one example of an operation of the information processing apparatus 100. FIG. 14 is a diagram for describing a detailed function of the information processing apparatus 100 and a flow of data. FIG. 15 is a diagram for describing a change of a record of a database during an operation flow in FIG. 13.

The flow in FIG. 13 further includes step S201 in the flow in FIG. 8. Further, step S203 is included instead of step S109 of the flow in FIG. 13. The specification unit 102 refers to the tag mode DB 118, and reflects, in a tag DB 114, a mode ID included in the tag mode DB 118 (step S201). FIG. 15A illustrates one example of the tag DB 114.

In step S203 in FIG. 13, a tag history addition function 134 saves, in a tag history DB 116, a tag whose active flag in the tag DB 114 is 1, in association with browsing information. In an example in FIG. 15C, screenshot saving of data is associated with a tag history ID (4), and no-data is associated with a tag history ID (5).

In this instance, when screenshot saving is associated with a tag, the storage processing unit 104 generates a screenshot image file of a browsed web page, and saves the generated file, in a predetermined folder of the storage apparatus 110, with a file name (path name) in accordance with a predetermined rule using a history ID, an access time, or the like, as described above.

Then, in step S113 in FIG. 13, pieces of data being relevant to the tag ID and history ID acquired in step S111 are acquired from the tag DB 114 and a history DB 112, respectively, and associated each other. In an example in FIG. 14, “screenshot saving” and “orange” are associated as a tag with browsing information of a history ID (3) in a history screen 210. Then, in step S115, a history viewer 138 displays the history screen 210. In this instance, the display processing unit 140 can read, from the storage apparatus 110, a file of a saved site from a path name being relevant to a history ID or an access time.

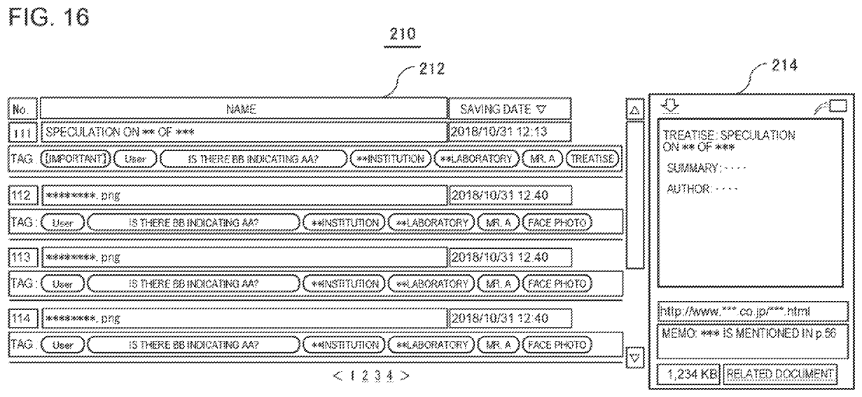

FIG. 16 is a diagram illustrating one example of the history screen 210. A data display column 214 is further included in addition to the history screen 210 in FIG. 11. The data display column 214 displays data saved in a saving mode specified by a tag being relevant to browsing information.

As described above, the information processing apparatus 100 according to the present example embodiment can save data of a browsed site in a specified mode, and, therefore, when accumulated information is browsed later, a web page can be seen without accessing the site. Thus, a burden on a communication band can be reduced by decreasing the number of accesses to a site.

### Third Example Embodiment

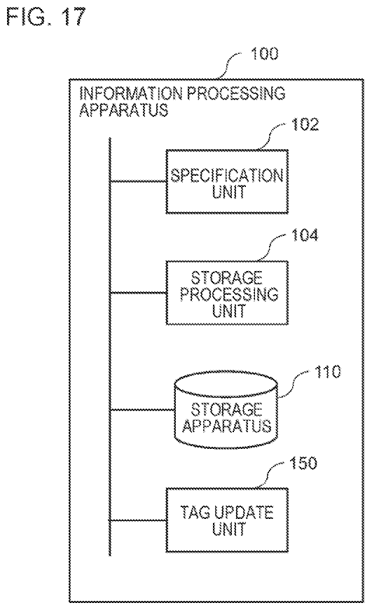

An information processing apparatus 100 according to the present example embodiment is the same as that according to each of the example embodiments described above except that a tag stored in a tag DB 114 can be edited. FIG. 17 is a functional block diagram illustrating a logical configuration of the information processing apparatus 100 according to the present example embodiment. The information processing apparatus 100 further includes a tag update unit 150 that accepts editing (changing, addition, or deletion) of a tag, and updates the tag according to a content of the editing.

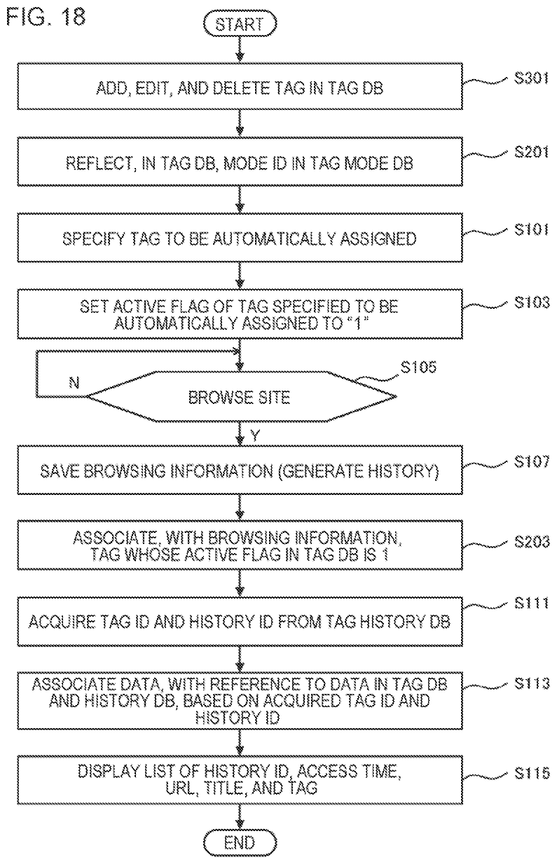

FIG. 18 is a flowchart illustrating one example of an operation of the information processing apparatus 100 according to the present example embodiment. A flow in FIG. 18 further includes step S301 in addition to the flow in FIG. 13.

A tag selection editor screen 200 includes a UI that accepts at least any one operation of addition, editing, and deletion of a tag. In step S301, the tag update unit 150 accepts at least any one of operations of addition, editing, and deletion of a tag by use of an editor screen of a tag, and updates the tag DB 114.

The tag update unit 150 accepts a tag being added, edited, or deleted by an operator by use of the tag selection editor screen 200 (FIG. 5), and updates the tag DB 114.

The tag selection editor screen 200 includes a tag column 202, and an active specification column 204 that specifies whether to assign, to browsing information, a tag input to the tag column 202. The tag column 202 is, for example, a text box, and an operator can input and add a tag desired to be assigned to the tag column 202, or edit an already input tag.

A user interface (UI) in the tag selection editor screen 200 in FIG. 5 is one example. Another example may be a list box, a combo box, a drumroll type selection box, or the like including a plurality of previously specified tag candidates. Moreover, although not illustrated, a UI (e.g., a delete button or the like) that deletes a tag input to the tag column 202 may be included.

As described above, the information processing apparatus 100 according to the present example embodiment can add, edit, and delete a tag, and, therefore, a tag to be assigned can be changed in process of information collection.

### Fourth Example Embodiment

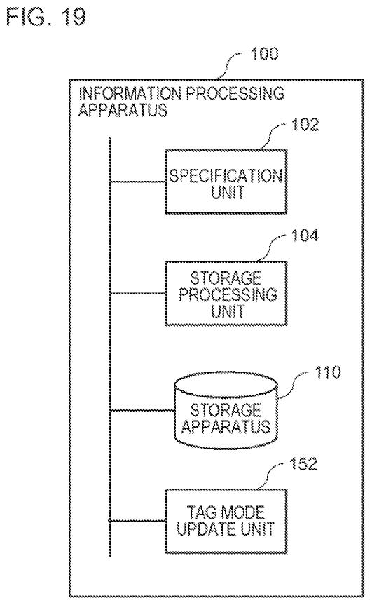

An information processing apparatus 100 according to the present example embodiment is the same as that according to each of the example embodiments described above except that a saving mode of a site can be edited. FIG. 19 is a functional block diagram illustrating a logical configuration of the information processing apparatus 100 according to the present example embodiment. The information processing apparatus 100 further includes a tag mode update unit 152 that accepts editing (changing, addition, or deletion) of a saving mode, and updates a saving mode of a tag mode DB 118 according to a content of the editing.

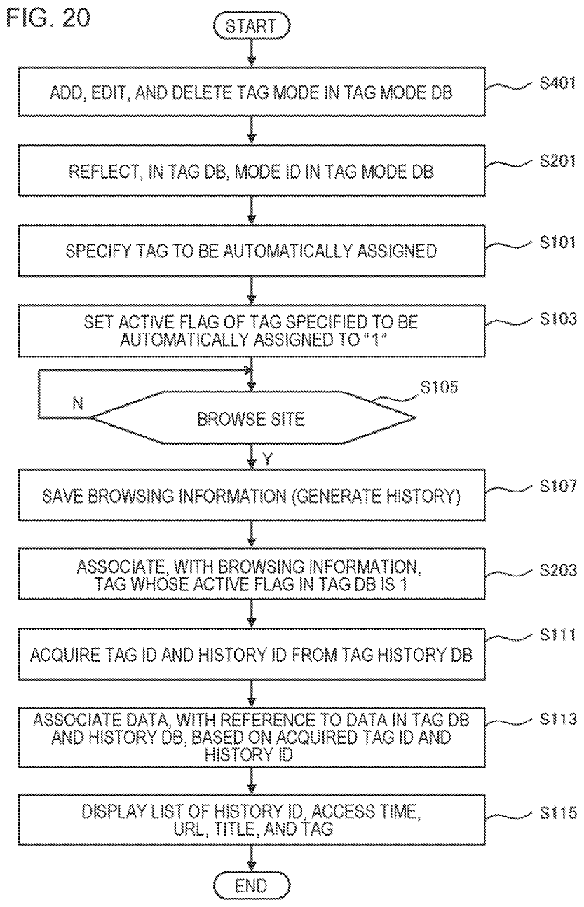

FIG. 20 is a flowchart illustrating one example of an operation of the information processing apparatus 100 according to the present example embodiment. A flow in FIG. 20 further includes step S401 in addition to the flow in FIG. 13.

A tag mode editing screen (not illustrated) includes a UI that accepts at least any one operation of addition, editing, and deletion of a tag mode. In step S401, the tag mode update unit 152 accepts at least any one of operation of addition, editing, and deletion of a tag mode by use of a tag mode editing screen, and updates the tag mode DB 118.

As described above, the information processing apparatus 100 according to the present example embodiment can add, edit, and delete a tag mode, and, therefore, a tag mode to be assigned can be changed in process of information collection.

### Fifth Example Embodiment

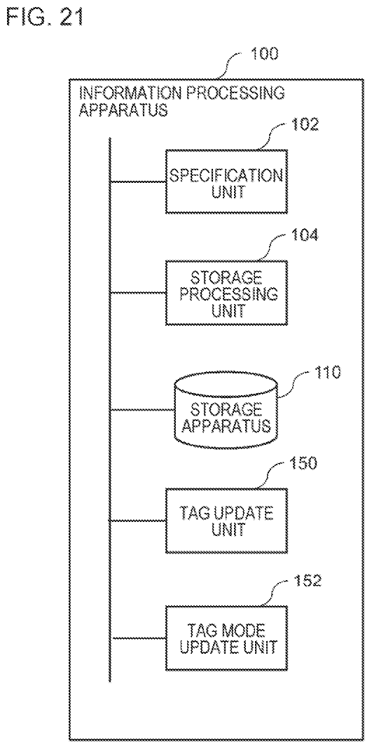

FIG. 21 is a functional block diagram illustrating a logical configuration of an information processing apparatus 100 according to the present example embodiment. The information processing apparatus 100 according to the present example embodiment includes both a tag update unit 150 according to the third example embodiment and a tag mode update unit 152 according to the fourth example embodiment.

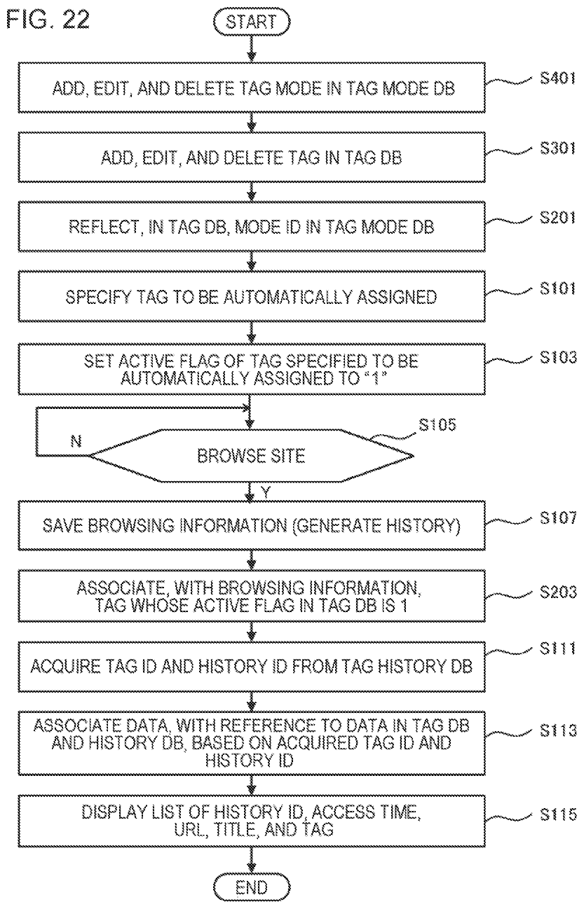

FIG. 22 is a flowchart illustrating one example of an operation of the information processing apparatus 100 according to the present example embodiment. A flow in FIG. 22 further includes steps S301 and S401 in addition to the flow in FIG. 13. The steps S301 and S401 in FIG. 22 are the same as step S301 in FIG. 18 and step S401 in FIG. 20.

The present example embodiment brings about an advantageous effect similar to that of each of the third and fourth example embodiments.

### Sixth Example Embodiment

An information processing apparatus 100 according to the present example embodiment differs from that according to each of the example embodiments described above in that a tag has a tree structure.

A tree structure of a plurality of tags is previously set.

A specification unit 102 accepts, as specified tags, a specified tag and a tag of a high order of the specified tag in the tree structure.

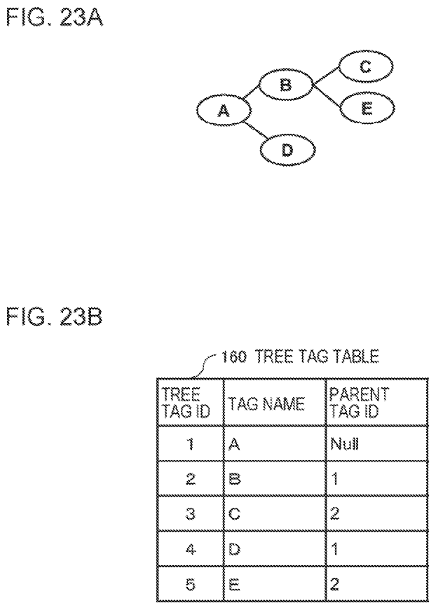

FIG. 23 is a diagram illustrating one example of a data structure of information relating to a tag of a tree structure.

When a tree structure of a plurality of tags whose tag names are “A”, “B”, “C”, “D”, and “E” as illustrated in FIG. 23A is previously determined, a tree structure is stored in a tree tag table 160 as illustrated in FIG. 23B. A tree tag ID is assigned to each tag, and, for each tag, an ID of its own parent (immediately preceding high-order layer) tag is associated and stored. The tag whose tag name is “A” is the tag of the highest order in itself, and, therefore, “Null” is set as a parent tag ID because no parent tag ID is present.

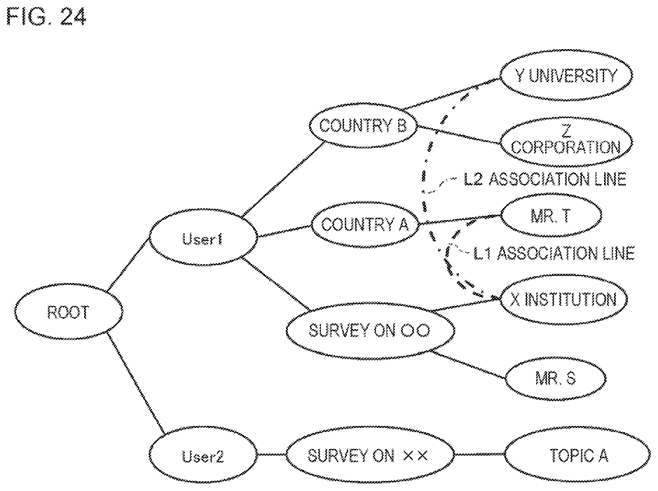

A display processing unit 140 further displays a tree structure of a plurality of tags on a display unit. The display processing unit 140 displays an added tag in such a way as to add, to the tree structure, a line associating the added tag with another tag. FIG. 24 is a diagram illustrating one example of a tree screen 220 indicated by a tree structure of a tag. In the tree screen 220, “Mr. T” and “X institution” that are linked by an association line L1 indicated by a broken line are tags that are related by an operator later. Further, “Y university” and “X institution” that are linked by an association line L2 indicated by a one-dot chain line are also tags that are related by an operator later.

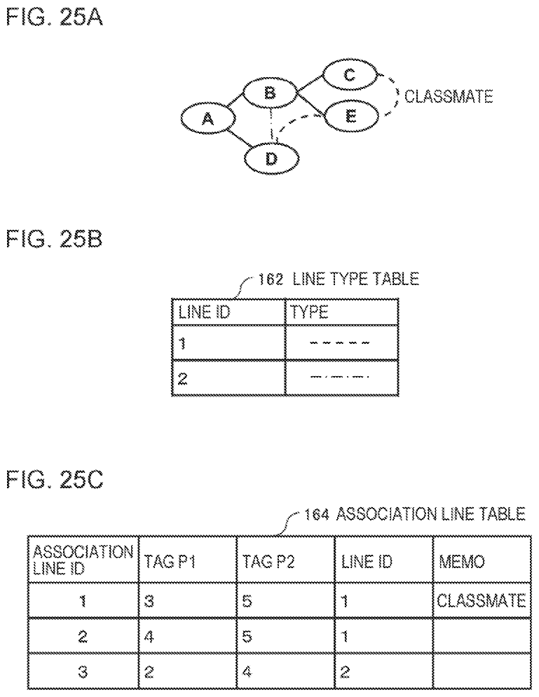

FIG. 25 is a diagram illustrating an example of a data structure of information relating to an association line added to the tag of the tree structure in FIG. 23. For example, it is assumed that a tree structure as illustrated in FIG. 23A is screen-displayed. An operator selects a pair of two tags (referred to as P1 and P2) desired to be linked by an association line, and the kind of line. Note that, the information processing apparatus 100 according to the present example embodiment accepts an operation by an operator on a screen by a graphical user interface (GUI).

As one example, first, as illustrated in FIG. 25A, it is assumed that the tag C and the tag E are selected, and linked by an association line being a broken line. According to a line type table 162 illustrated in FIG. 25B, a line ID whose type is a broken line is 1. FIG. 25C is a diagram illustrating one example of a data structure of an association line table 164. An association line ID is assigned to each association line, and tag IDs of the pair of the tags P1 and P2 linked by an association line, and a line ID indicating a line type of the association line are relevantly stored in the association line table 164. Further, a memo input by an operator can be attached to an association line, and a content of the input memo is also relevantly stored in the association line table 164. Herein, a memo “classmate” attached to the association line of the tag C and the tag E is stored.

Similarly, the tag D and the tag E are linked by a broken line, and stored in the association line table 164 as an association line ID2. Further, the tag B and the tag D are linked by a one-dot chain line, and stored in the association line table 164 as an association line ID3. A line type ID of a one-dot chain line is 2. Note that, in order to differentiate an association line, a color of a line or thickness of a line may be varied, in addition to changing a line type such as a full line, a broken line, a one-dot chain line, a two-dot chain line, and a double line. A plurality of differing association lines may be stored in the line type table 162 with at least one of a line type, a color of a line, and thickness of a line varied. An operator may select from among a plurality of differing association lines previously prepared in the line type table 162, or association lines being specified by an operator and differing in line type, a color of a line, and thickness of a line may be stored in the line type table 162.

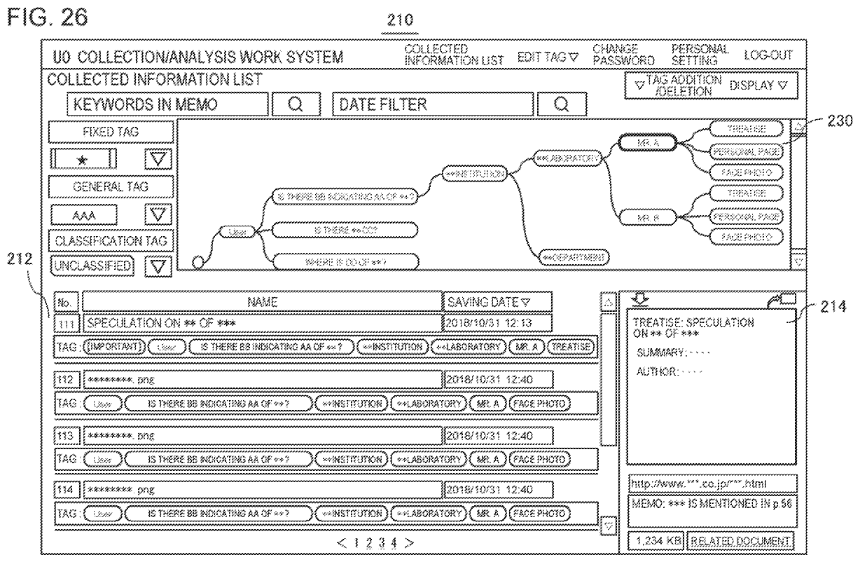

FIG. 26 is a diagram illustrating an example in which a tree structure display unit 230 is further included in a history screen 210.

The specification unit 102 can also accept a selection of a tag to be specified, on the tree structure display unit 230. For example, when a tag “Mr. A” is tag-specified (an active flag is set to “1”), all of a plurality of tags (user, whether BB indicating AA of ** is present, ** institution, ** laboratory) located at higher orders than “Mr. A” are automatically assigned to browsing information accessed later.

Moreover, editing of a tree structure of a tag can also be performed on the tree structure display unit 230. A tree structure may be able to be generated by use of a graphical user interface (GUI).

As described above, since the present example embodiment can specify a plurality of tags by a tree structure, a plurality of tags can be efficiently and automatically related to each other, and associated with browsing information. Moreover, since a tag can be systematically assigned owing to a tree structure, an information analysis can be performed more efficiently. Since browsing information accumulated by use of a plurality of tags in combination can be extracted, necessary information can be efficiently acquired.

While the example embodiments of the present invention have been described above with reference to the drawings, the example embodiments are exemplifications of the present invention, and various configurations other than those described above can be adopted.

For example, the specification unit 102 may accept another tag by a user input. For example, in the history screen 210, a specification of a tag to be added to browsing information may be accepted. The storage processing unit 104 stores the added another tag in association with the browsing information. Specifically, the storage processing unit 104 associates a tag ID of the added another tag with a history ID of the browsing information, and updates the tag history DB 116.

Moreover, although a tag assigned to browsing information is managed by the tag history DB 116 in the configuration according to each of the example embodiments described above, the storage processing unit 104 may directly associate and store a tag itself assigned to each piece of browsing information in the history DB 112, or a tag ID thereof, in another example embodiment.

While the invention of the present application has been described above with reference to the example embodiments and examples, the invention of the present application is not limited to the example embodiments and examples described above. Various modifications understandable to a person skilled in the art can be made to a configuration and details of the invention of the present application within the scope of the invention of the present application.

Note that, when information relating to a user is acquired and utilized in the present invention, the acquisition and utilization are performed legally.

Some or all of the above-described example embodiments can also be described as, but are not limited to, the following supplementary notes.

1. An information processing apparatus including:

a specification unit that accepts a plurality of tags being specified at a timing before an input for a search; and

a storage processing unit that stores, in a storage unit, browsing information including a uniform resource locator (URL) of a browsed web page, in association with the specified tags.

2. The information processing apparatus according to supplementary note 1, wherein

the storage processing unit further stores, in the storage unit, a title of the browsed web page in such a way as to further include in the browsing information, and

the information processing apparatus further including

a display processing unit that displays, on a display unit, the title of the web page and the tags in association with each other.

3. The information processing apparatus according to supplementary note 1 or 2, wherein

a plurality of the tags are previously stored in a storage unit,

the specification unit accepts at least one tag being specified from among a plurality of the tags stored in the storage unit, and

the storage processing unit stores, in the storage unit, the tag specified at browsing of the web page, in association with the URL.

4. The information processing apparatus according to supplementary note 3, wherein

the specification unit accepts another tag by a user input, and the storage processing unit adds the another tag to the browsing information.

5. The information processing apparatus according to supplementary note 4, wherein

the plurality of tags have a tree structure which is previously set, and

the specification unit accepts, as specified tags, a specified tag and a tag of a high order of the specified tag in the tree structure.

6. The information processing apparatus according to supplementary note 5, further including

a display processing unit that displays a tree structure of a plurality of tags on a display unit, wherein

the display processing unit displays the added tag in such a way as to add, to the tree structure, a line associating the added tag with another tag.

7. The information processing apparatus according to any one of supplementary notes 1 to 6, further including

a tag update unit that accepts editing of the tag, and updates the tag according to a content of the editing.

8. The information processing apparatus according to any one of supplementary notes 1 to 7, wherein

the specification unit accepts specifying a saving mode of the web page, and the storage processing unit stores the web page in the specified saving mode.

9. The information processing apparatus according to supplementary note 8, further including

a display processing unit that displays the saved web page on a display unit.

10. The information processing apparatus according to supplementary note 8 or 9, further including

a mode update unit that accepts editing of the saving mode, and updates the saving mode according to a content of the editing.

11. An information processing method executed by an information processing apparatus, the method including

accepting a plurality of tags being specified at a timing before an input for a search; and

storing, in a storage unit, browsing information including a uniform resource locator (URL) of a browsed web page, in association with the specified tags.

12. The information processing method executed by the information processing apparatus according to supplementary note 11, the method further including:

further storing, in the storage unit, a title of the browsed web page in such a way as to further include in the browsing information; and

displaying, on a display unit, the title of the web page and the tags in association with each other.

13. The information processing method executed by the information processing apparatus according to supplementary note 11 or 12, the method further including:

previously storing a plurality of the tags in a storage unit;

accepting at least one tag being specified from among a plurality of the tags stored in the storage unit; and

storing, in the storage unit, the tag specified at browsing of the web page, in association with the URL.

14. The information processing method executed by the information processing apparatus according to supplementary note 13, the method further including:

accepting another tag by a user input; and

adding the another tag to the browsing information.

15. The information processing method executed by the information processing apparatus according to supplementary note 14, the method further including,

with the plurality of tags having a tree structure which is previously set,

accepting, as specified tags, a specified tag and a tag of a high order of the specified tag in the tree structure.

16. The information processing method executed by the information processing apparatus according to supplementary note 15, the method further including:

displaying a tree structure of a plurality of tags on a display unit; and

displaying the added tag in such a way as to add, to the tree structure, a line associating the added tag with another tag.

17. The information processing method executed by the information processing apparatus according to any one of supplementary notes 11 to 16, the method further including,

accepting editing of the tag, and updating the tag according to a content of the editing.

18. The information processing method executed by the information processing apparatus according to any one of supplementary notes 11 to 17, the method further including:

accepting specifying a saving mode of the web page; and

storing the web page in the specified saving mode.

19. The information processing method executed by the information processing apparatus according to supplementary note 18, the method further including,

displaying the saved web page on a display unit.

20. The information processing method executed by the information processing apparatus according to supplementary note 18 or 19, the method further including,

accepting editing of the saving mode, and updating the saving mode according to a content of the editing.

21. A program for causing a computer to execute:

a procedure of accepting a plurality of tags being specified at a timing before an input for a search; and

a procedure of storing, in a storage unit, browsing information including a uniform resource locator (URL) of a browsed web page, in association with the specified tags.

22. The program according to supplementary note 21, causing a computer to execute:

a procedure of further storing, in the storage unit, a title of the browsed web page in such a way as to further include in the browsing information; and

a procedure of displaying, on a display unit, the title of the web page and the tags in association with each other.

23. The program according to supplementary note 21 or 22, causing a computer to execute:

a procedure of previously storing a plurality of the tags in a storage unit;

a procedure of accepting at least one tag being specified from among a plurality of the tags stored in the storage unit; and

a procedure of storing, in the storage unit, the tag specified at browsing of the web page, in association with the URL.

24. The program according to supplementary note 23, causing a computer to execute:

the specification unit, a procedure of accepting another tag by a user input; and

the storage processing unit, a procedure of adding the another tag to the browsing information.

25. The program according to supplementary note 24, wherein the plurality of tags have a tree structure being previously set, and

the program causes a computer to execute

a procedure of accepting, as specified tags, a specified tag and a tag of a high order of the specified tag in the tree structure.

26. The program according to supplementary note 25, causing a computer to execute:

a procedure of displaying a tree structure of a plurality of tags on a display unit; and

a procedure of displaying the added tag in such a way as to add, to the tree structure, a line associating the added tag with another tag.

27. The program according to any one of supplementary notes 21 to 26, causing a computer to execute

a procedure of accepting editing of the tag, and updating the tag according to a content of the editing.

28. The program according to any one of supplementary notes 21 to 27, causing a computer to execute:

a procedure of accepting specifying a saving mode of the web page; and

a procedure of storing the web page in the specified saving mode.

29. The program according to supplementary note 28, causing a computer to execute

a procedure of displaying the saved web page on a display unit.

30. The program according to supplementary note 28 or 29, causing a computer to execute

a procedure of accepting editing of the saving mode, and updating the saving mode according to a content of the editing.

This application is based upon and claims the benefit of priority from Japanese Patent Application No. 2019-164594, filed on Sep. 10, 2019, the disclosure of which is incorporated herein in its entirety by reference.

### REFERENCE SIGNS LIST

3 Communication network
60 Computer
62 CPU
64 Memory
66 Storage
68 I/O
69 Bus
70 Communication I/F
72 Input apparatus
74 Display apparatus
80 Program
100 Information processing apparatus
102 Specification unit
104 Storage processing unit
110 Storage apparatus
112 History DB
114 Tag DB
116 Tag history DB
118 Tag mode DB
120 Processing
130 Page display unit
132 History generation function
134 Tag history addition function
136 Tag selection editor
138 History viewer
140 Display processing unit
150 Tag update unit
152 Tag mode update unit
200 Tag selection editor screen
202 Tag column
204 Active specification column
210 History screen
212 Browsing information list display column
214 Data display column
220 Tree screen
230 Tree structure display unit

What is claimed is:

1. An information processing apparatus comprising:
a specification unit that accepts a plurality of tags being specified at a timing before an input for a search; and
a storage processing unit that stores, in a storage unit, browsing information including a uniform resource locator (URL) of a browsed web page, in association with the specified tags.

2. The information processing apparatus according to claim 1, wherein
the storage processing unit further stores, in the storage unit, a title of the browsed web page in such a way as to further include in the browsing information, and
the information processing apparatus further comprising
a display processing unit that displays, on a display unit, the title of the web page and the tags in association with each other.

3. The information processing apparatus according to claim 1, wherein
a plurality of the tags are previously stored in a storage unit,
the specification unit accepts at least one tag being specified from among the plurality of the tags stored in the storage unit, and
the storage processing unit stores, in the storage unit, the tag specified at browsing of the web page, in association with the URL.

4. The information processing apparatus according to claim 3, wherein
the specification unit accepts another tag by a user input, and
the storage processing unit adds the another tag to the browsing information.

5. The information processing apparatus according to claim 4, wherein
the plurality of tags have a tree structure which is previously set, and
the specification unit accepts, as specified tags, a specified tag and a tag of a high order of the specified tag in the tree structure.

6. The information processing apparatus according to claim 5, further comprising
a display processing unit that displays a tree structure of a plurality of tags on a display unit, wherein
the display processing unit displays the added tag in such a way as to add, to the tree structure, a line associating the added tag with another tag.

7. The information processing apparatus according to claim 1, further comprising
a tag update unit that accepts editing of the tag, and updates the tag according to a content of the editing.

8. The information processing apparatus according to claim 1, wherein
the specification unit accepts specifying a saving mode of the web page, and
the storage processing unit stores the web page in the specified saving mode.

9. The information processing apparatus according to claim 8, further comprising
a display processing unit that displays the saved web page on a display unit.

10. The information processing apparatus according to claim 8, further comprising
a mode update unit that accepts editing of the saving mode, and updates the saving mode according to a content of the editing.

11. An information processing method executed by an information processing apparatus, the method comprising:
accepting a plurality of tags being specified at a timing before an input for a search; and
storing, in a storage unit, browsing information including a uniform resource locator (URL) of a browsed web page, in association with the specified tags.

12. The information processing method executed by the information processing apparatus according to claim 11, the method further comprising:
further storing, in the storage unit, a title of the browsed web page in such a way as to further include in the browsing information; and
displaying, on a display unit, the title of the web page and the tags in association with each other.

13. The information processing method executed by the information processing apparatus according to claim 11, the method further comprising:
previously storing a plurality of the tags in a storage unit;
accepting at least one tag being specified from among a plurality of the tags stored in the storage unit; and
storing, in the storage unit, the tag specified at browsing of the web page, in association with the URL.

14. The information processing method executed by the information processing apparatus according to claim 13, the method further comprising:
accepting another tag by a user input; and
adding the another tag to the browsing information.

15. The information processing method executed by the information processing apparatus according to claim 14, wherein the plurality of tags having a tree structure which is previously set, and the method further comprising,
accepting, as specified tags, a specified tag and a tag of a high order of the specified tag in the tree structure.

16. The information processing method executed by the information processing apparatus according to claim 15, the method further comprising:
displaying a tree structure of a plurality of tags on a display unit; and
displaying the added tag in such a way as to add, to the tree structure, a line associating the added tag with another tag.

17. The information processing method executed by the information processing apparatus according to claim 11, the method further comprising,
accepting editing of the tag, and updating the tag according to a content of the editing.

18. The information processing method executed by the information processing apparatus according to claim 11, the method further comprising:
accepting specifying a saving mode of the web page; and
storing the web page in the specified saving mode.

19. The information processing method executed by the information processing apparatus according to claim 18, the method further comprising,
displaying the saved web page on a display unit.

20. The information processing method executed by the information processing apparatus according to claim 18, the method further comprising,
accepting editing of the saving mode, and updating the saving mode according to a content of the editing.

21. A non-transitory computer-readable storage medium storing a program for causing a computer to execute:
a procedure of accepting a plurality of tags being specified at a timing before an input for a search; and
a procedure of storing, in a storage unit, browsing information including a uniform resource locator (URL) of a browsed web page, in association with the specified tags.

22.-30. (canceled)
